(19) United States
(12) Patent Application Publication
(10) Pub. No.: US 2023/0161999 A1
(43) Pub. Date: May 25, 2023

(54) REGRESSION PROCESSING DEVICE CONFIGURED TO EXECUTE REGRESSION PROCESSING USING MACHINE LEARNING MODEL, METHOD, AND NON-TRANSITORY COMPUTER-READABLE STORAGE MEDIUM STORING COMPUTER PROGRAM

(71) Applicant: SEIKO EPSON CORPORATION, TOKYO (JP)

(72) Inventors: Hikaru KURASAWA, Matsumoto-shi (JP); Shin NISHIMURA, Shiojiri-shi (JP)

(21) Appl. No.: 18/058,278

(22) Filed: Nov. 23, 2022

(30) Foreign Application Priority Data
Nov. 24, 2021 (JP) 2021-189877

(51) Int. Cl. G06N 3/04; G06N 3/08

(52) U.S. Cl. CPC G06N 3/04; G06N 3/08

(57) ABSTRACT

A regression processing unit is configured to execute processing (a) of obtaining a predicted output value with respect to input data using a machine learning model, processing (b) of reading out a known feature spectrum group from a memory, processing (c) of calculating a degree of similarity relating to the predicted output value between the known feature spectrum group and a feature spectrum obtained from an output of a specific layer when the input data is input to the machine learning model, and processing (d) of outputting the predicted output value using the degree of similarity.

The present application is based on, and claims priority from JP Application Serial Number 2021-189877, filed Nov. 24, 2021, the disclosure of which is hereby incorporated by reference herein in its entirety.

### BACKGROUND

### 1. Technical Field

The present disclosure relates to a regression processing device configured to execute regression processing using a machine learning model, a method, and a non-transitory computer-readable storage medium storing a computer program.

### 2. Related Art

U.S. Pat. No. 5,210,798 and WO 2019/083553 each disclose a so-called capsule network as a machine learning model of a vector neural network type using a vector neuron. The vector neuron indicates a neuron where an input and an output are in a vector expression. The capsule network is a machine learning model where the vector neuron called a capsule is a node of a network. The vector neural network-type machine learning model such as a capsule network is applicable to input data classification processing.

However, there has not been sufficient examination on application of the vector neural network to regression processing in the related art, and hence a technique enabling highly accurate regression processing using the vector neural network has been desired.

### SUMMARY

According to a first aspect of the present disclosure, there is provided a regression processing device configured to execute regression processing of obtaining a predicted output value with respect to input data using a machine learning model including a vector neural network including a plurality of vector neuron layers. The regression processing device includes a regression processing unit configured to execute the regression processing, and a memory configured to store a known feature spectrum group obtained from an output of a specific layer of the machine learning model when a plurality of pieces of teaching data are input to the machine learning model. The regression processing unit is configured to execute processing (a) of obtaining the predicted output value with respect to the input data using the machine learning model, processing (b) of reading out the known feature spectrum group from the memory, processing (c) of calculating a degree of similarity relating to the predicted output value between the known feature spectrum group and a feature spectrum obtained from an output of the specific layer when the input data is input to the machine learning model, and processing (d) of outputting the predicted output value using the degree of similarity.

According to a second aspect of the present disclosure, there is provided a method of executing regression processing of obtaining a predicted output value with respect to input data using a machine learning model including a vector neural network including a plurality of vector neuron layers. The method includes (a) obtaining the predicted output value with respect to the input data using the machine learning model, (b) reading out, from a memory, a known feature spectrum group obtained from an output of a specific layer of the machine learning model when a plurality of pieces of teaching data are input to the machine learning model, (c) calculating a degree of similarity relating to the predicted output value between the known feature spectrum group and a feature spectrum obtained from an output of the specific layer when the input data is input to the machine learning model, and (d) outputting the predicted output value using the degree of similarity.

According to a third aspect of the present disclosure, there is provided a non-transitory computer-readable storage medium storing a computer program for causing a processor to execute regression processing of obtaining a predicted output value with respect to input data using a machine learning model including a vector neural network including a plurality of vector neuron layers. The computer program causes the processor to (a) obtain the predicted output value with respect to the input data using the machine learning model, (b) read out, from a memory, a known feature spectrum group obtained from an output of a specific layer of the machine learning model when a plurality of pieces of teaching data are input to the machine learning model, (c) calculate a degree of similarity relating to the predicted output value between the known feature spectrum group and a feature spectrum obtained from an output of the specific layer when the input data is input to the machine learning model, and (d) output the predicted output value using the degree of similarity.

### BRIEF DESCRIPTION OF THE DRAWINGS

FIG. 1 is a block diagram illustrating a regression processing system in an exemplary embodiment.

FIG. 2 is an explanatory diagram illustrating a configuration example of a machine learning model.

FIG. 3 is a flowchart illustrating a processing procedure of preparation steps.

FIG. 4 is an explanatory diagram illustrating a state in which teaching data is generated from sample data.

FIG. 5 is an explanatory diagram illustrating a feature spectrum.

FIG. 6 is an explanatory diagram illustrating a configuration of a known feature spectrum group.

FIG. 7 is a flowchart illustrating a process procedure of regression processing steps.

FIG. 8 is an explanatory diagram illustrating an output example of a regression processing result.

FIG. 9 is an explanatory diagram illustrating another output example of a regression processing result.

FIG. 10 is an explanatory diagram further illustrating another output example of a regression processing result.

FIG. 11 is an explanatory diagram illustrating an experiment result of regression processing using a machine learning model that is previously learned.

FIG. 12 is an explanatory diagram illustrating a first arithmetic method for obtaining a degree of similarity.

FIG. 13 is an explanatory diagram illustrating a second arithmetic method for obtaining a degree of similarity.

FIG. 14 is an explanatory diagram illustrating a third arithmetic method for obtaining a degree of similarity.

### DESCRIPTION OF EXEMPLARY EMBODIMENTS

### A. Exemplary Embodiment

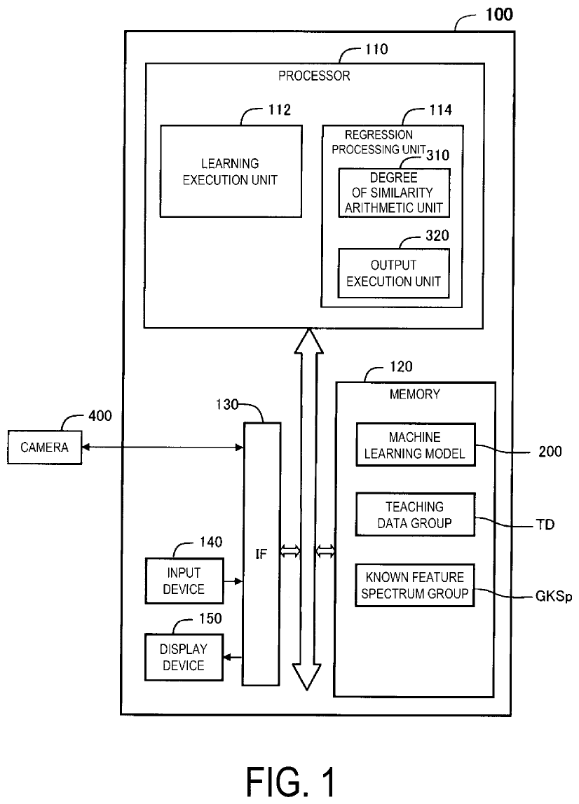

FIG. 1 is a block diagram illustrating a regression processing system in an exemplary embodiment. The regression processing system includes an information processing device 100 and a camera 400. The camera 400 captures an image being learning data for regression processing. A camera that captures a color image may be used as the camera 400. Alternatively, a camera that captures a monochrome image or a spectral image may be used. In the present exemplary embodiment, an image captured by the camera 400 is used as teaching data or input data. Alternatively, data other than an image may be used as teaching data or input data. In such a case, an input data reading device selected in accordance with a data type is used in place of the camera 400.

The information processing device 100 includes a processor 110, a memory 120, an interface circuit 130, and an input device 140 and a display device 150 that are coupled to the interface circuit 130. The camera 400 is also coupled to the interface circuit 130. Although not limited thereto, for example, the processor 110 is provided with a function of executing processing, which is described below in detail, as well as a function of displaying, on the display device 150, data obtained through the processing and data generated in the course of the processing.

The processor 110 functions as a learning execution unit 112 that executes learning of a machine learning model and a regression processing unit 114 that executes regression processing for input data. The regression processing unit 114 includes a degree of similarity arithmetic unit 310 and an output execution unit 320. Each of the learning execution unit 112 and the regression processing unit 114 are implemented when the processor 110 executes a computer program stored in the memory 120. Alternatively, the learning execution unit 112 and the regression processing unit 114 may be implemented with a hardware circuit. The processor in the present disclosure is a term including such a hardware circuit. Further, one or a plurality of processors that execute learning processing or regression processing may be a processor included in one or a plurality of remote computers that are coupled via a network.

In the memory 120, a machine learning model 200, a teaching data group TD, and a known feature spectrum group GKSp are stored. The machine learning model 200 is used for processing executed by the regression processing unit 114. A configuration example and an operation of the machine learning model 200 are described later. The teaching data group TD is a group of labeled data used for learning of the machine learning model 200. In the present exemplary embodiment, the teaching data group TD is a set of image data. The known feature spectrum group GKSp is a set of feature spectra that are obtained by inputting teaching data to the machine learning model 200 that is previously learned. The feature spectrum is described later.

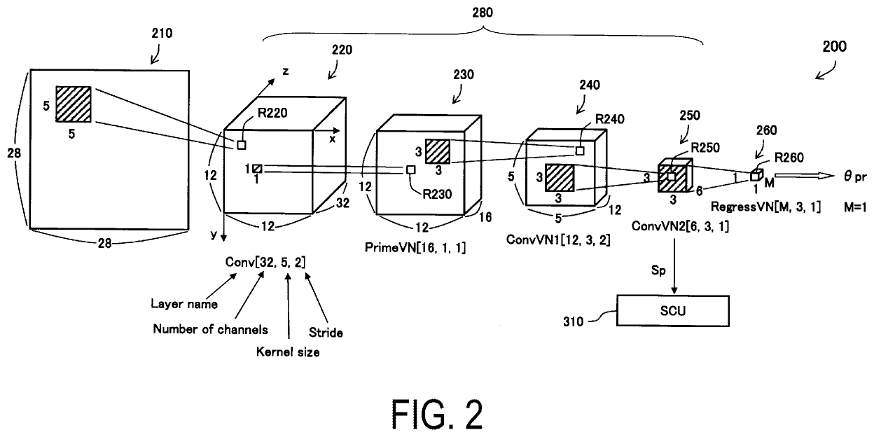

FIG. 2 is an explanatory diagram illustrating a configuration of the machine learning model 200. The machine learning model 200 has an input layer 210, an intermediate layer 280, and an output layer 260. The intermediate layer 280 includes a convolution layer 220, a primary vector neuron layer 230, a first convolution vector neuron layer 240, and a second convolution vector neuron layer 250. The output layer 260 is also referred to as a “regression vector neuron layer 260”. Among those layers, the input layer 210 is the lowermost layer, and the output layer 260 is the uppermost layer. In the following description, the layers in the intermediate layer 280 are referred to as the “Cony layer 220”, the “PrimeVN layer 230”, the “ConvVN1 layer 240”, and the “ConvVN2 layer 250”, respectively. The output layer 260 is referred to as the “RegressVN layer 260”.

In the example of FIG. 2, the two convolution vector neuron layers 240 and 250 are used. However, the number of convolution vector neuron layers is freely selected, and the vector neuron layers may be omitted. However, it is preferred that one or more convolution vector neuron layers be used.

An image having a size of 28×28 pixels is input into the input layer 210. A configuration of each of the layers other than the input layer 210 is described as follows.
Conv layer 220: Conv [32, 5, 2]
PrimeVN layer 230: PrimeVN [16, 1, 1]
ConvVN1 layer 240: ConvVN1 [12, 3, 2]
ConvVN2 layer 250: ConvVN2 [6, 3, 1]
RegressVN layer 260: RegressVN [M, 3, 1]
Vector dimension VD: VD=16

In the description for each of the layers, the character string before the brackets indicates a layer name, and the numbers in the brackets indicate the number of channels, a kernel surface size, and a stride in the stated order. For example, the layer name of the Conv layer 220 is “Conv”, the number of channels is 32, the kernel surface size is 5×5, and the stride is two. In FIG. 2, such description is given below each of the layers. A rectangular shape with hatching in each of the layers indicates the kernel surface size that is used for calculating an output vector of an adjacent upper layer. In the present exemplary embodiment, input data is in a form of image data, and hence the kernel surface size is also two-dimensional. Note that the parameter values used in the description of each of the layers are merely examples, and may be changed freely.

Each of the input layer 210 and the Conv layer 220 is a layer configured as a scholar neuron. Each of the other layers 230 to 260 is a layer configured as a vector neuron. The vector neuron is a neuron where an input and an output are in a vector expression. In the description given above, the dimension of an output vector of an individual vector neuron is 16, which is constant. In the description given below, the term “node” is used as a superordinate concept of the scholar neuron and the vector neuron.

In FIG. 2, with regard to the Conv layer 220, a first axis x and a second axis y that define plane coordinates of node arrangement and a third axis z that indicates a depth are illustrated. Further, it is shown that the sizes in the Conv layer 220 in the directions x, y, and z are 12, 12, and 32. The size in the direction x and the size in the direction y indicate the “resolution”. The size in the direction z indicates the number of channels. Those three axes x, y, and z are also used as the coordinate axes expressing a position of each node in the other layers. However, in FIG. 2, illustration of those axes x, y, and z is omitted for the layers other than the Conv layer 220.

As is well known, a resolution W1 after convolution is given with the following equation.

W1=Ceil{(W0−Wk+1)/S} (A1)

Here, W0 is a resolution before convolution, Wk is the kernel surface size, S is the stride, and Ceil{X} is a function of rounding up digits after the decimal point in the value X.

The resolution of each of the layers illustrate in FIG. 2 is an example while assuming that the resolution of the input data is 28, and the actual resolution of each of the layers is changed appropriately in accordance with a size of the input data.

The RegressVN layer 260 has M channels. M is the number of predicted output values that are output from the machine learning model 200. In the present exemplary embodiment, M is one, and one predicted output value θpr is output. The predicted output value θpr is not a discrete value but a continuous value. The number M of predicted output values may be two or more. For example, when a three-dimensional object image is used as input data, the machine learning model 200 may be configured so that three rotation angles about three axes thereof are obtained as predicted output values.

As an active function of the RegressVN layer 260, the linear function in Equation (A2) may be used.

[Mathematical Expression 1]

aⱼ=∥uⱼ∥ (A2)

Here, aⱼ indicates a norm of an output vector after activation in the j-th neuron in the layer, uⱼ is an output vector before activation in the j-th neuron in the layer, and indicates a norm of a vector uⱼ. In other words, an output of the RegressVN layer 260 is a value corresponding to a length of the vector uⱼ before activation.

As an active function of the RegressVN layer 260, various functions other than the linear function in Equation (A2) given above may be used. However, a softmax function is not suitable. A freely-selected active function may be used for a layer other than the RegressVN layer 260.

In FIG. 2, a partial region Rn is further illustrated in each of the layers 220, 230, 240, 250, and 260. The suffix “n” of the partial region Rn indicates the reference symbol of each of the layers. For example, the partial region R220 indicates the partial region in the Conv layer 220. The “partial region Rn” is a region of each of the layers that is specified with a plane position (x, y) defined by a position in the first axis x and a position in the second axis y and includes a plurality of channels along the third axis z. The partial region Rn has a dimension “Width”×“Height”×“Depth” corresponding to the first axis x, the second axis y, and the third axis z. In the present exemplary embodiment, the number of nodes included in one “partial region Rn” is “1×1×the number of depths”, that is, “1×1×the number of channels”.

As illustrated in FIG. 2, a feature spectrum Sp described later is calculated from an output of the ConvVN2 layer 250, and is input to the degree of similarity arithmetic unit 310. The degree of similarity arithmetic unit 310 calculates a degree of similarity described later using the feature spectrum Sp and the known feature spectrum group GKSp that is generated in advance. In the present exemplary embodiment, the predicted output value θpr is output using the degree of similarity. A method of outputting the predicted output value θpr is further described later.

In the present disclosure, a vector neuron layer used for calculation of the degree of similarity is also referred to as a “specific layer”. As the specific layer, the vector neuron layers other than the ConvVN2 layer 250 may be used. One or more vector neuron layers may be used, and the number of vector neuron layers is freely selectable. Note that a configuration of the feature spectrum and an arithmetic method of the degree of similarity using the feature spectrum are described later.

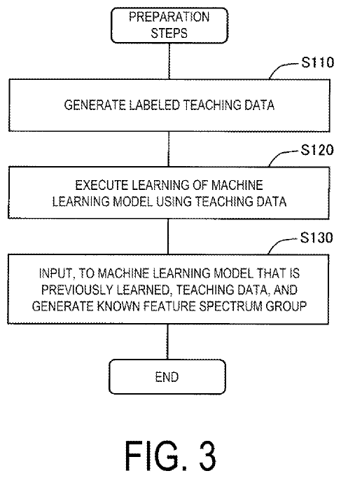

FIG. 3 is a flowchart illustrating a processing procedure of preparation steps of the machine learning model. In Step S110, the learning execution unit 112 generates labeled teaching data.

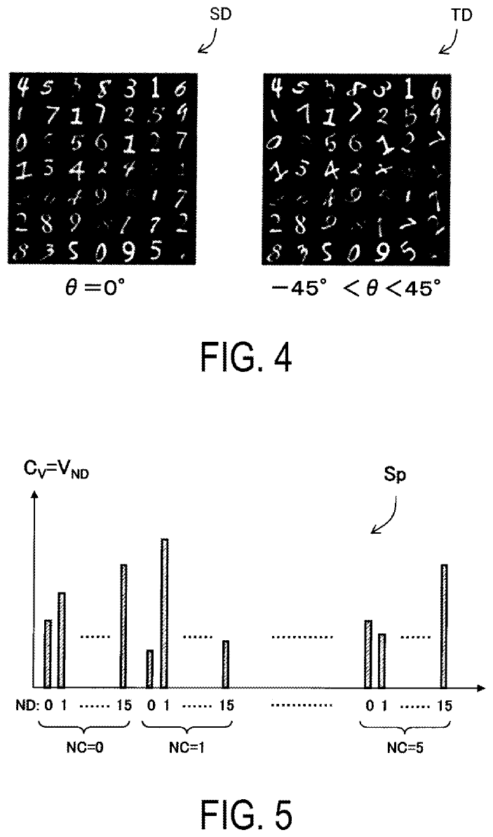

FIG. 4 is an explanatory diagram illustrating a state in which labeled teaching data is generated. Here, an image showing a plurality of hand-written characters relating to numerals 0 to 9 is captured as a sample image SD by the camera 400. The sample image SD contains an image of 49 hand-written characters. A size of each character image is 28×28 pixels. The teaching data TD is generated by randomly rotating each character in the sample image SD by a range of −45 degrees <θ<45 degrees. In the present exemplary embodiment, 5,000 sheets of such teaching data DT are prepared. An individual character image is provided with a value of the rotation angle θ as a label. More specifically, a value obtained through normalization by dividing the rotation angle θ by 180 and adding 5.0 to the resultant is used as a label for learning. In this case, the rotation angle θ from −45 degrees to +45 degrees is converted into a label falling within a range from 4.75 to 5.25. Learning of the machine learning model 200 is executed using such a label. With this, even an angle that does not fall within the range from −45 degrees to +45 degrees may possibly be obtained as the predicted output value θpr with respect to freely selected input data.

In Step S120, the learning execution unit 112 uses the teaching data group TD, and thus executes learning of the machine learning model 200. A freely selected loss function may be used at the time of learning. In the present exemplary embodiment, Mean Square Error (MSE) is used. After completion of learning, the machine learning model 200 that is previously learned is stored in the memory 120.

In Step S130, the learning execution unit 112 inputs a plurality of pieces of teaching data again to the machine learning model 200 that is previously learned, and generates the known feature spectrum group GKSp. The known feature spectrum group GKSp is a set of feature spectra, which is described later.

FIG. 5 is an explanatory diagram illustrating the feature spectrum Sp obtained by inputting freely-selected input data into the machine learning model 200 that is previously learned. As illustrated in FIG. 2, in the present exemplary embodiment, the feature spectrum Sp is generate from an output of the ConvVN2 layer 250. The horizontal axis in FIG. 5 indicates positions of vector elements relating to output vectors of a plurality of nodes included in one partial region R250 of the ConvVN2 layer 250. Each of the positions of the vector elements is expressed in a combination of an element number ND of the output vector and the channel number NC at each node. In the present exemplary embodiment, the vector dimension is 16 (the number of elements of the output vector being output from each node), and hence the element number ND of the output vector is denoted with 0 to 15, which is sixteen in total. Further, the number of channels of the ConvVN2 layer 250 is six, and thus the channel number NC is denoted with 0 to 5, which is six in total. In other words, the feature spectrum Sp is obtained by arranging the plurality of element values of the output vectors of each of the vector neurons included in one partial region R250, over the plurality of channels along the third axis z.

The vertical axis in FIG. 5 indicates a feature value C_{V} at each of the spectrum positions. In this example, the feature value C_{V} is a value V_{ND} of each of the elements of the output vectors. The feature value C_{V} may be subjected to statistic processing such as centering to the average value 0. Note that, as the feature value C_{V}, a value obtained by multiplying the value V_{ND} of each of the elements of the output vectors by a normalization coefficient described later may be used. Alternatively, the normalization coefficient may directly be used. In the latter case, the number of feature values C_{V} included in the feature spectrum Sp is equal to the number of channels, which is six. Note that the normalization coefficient is a value corresponding to a vector length of the output vector of the node.

The number of feature spectra Sp that can be obtained from an output of the ConvVN2 layer 250 with respect to one piece of input data is equal to the number of plane positions (x, y) of the ConvVN2 layer 250, in other words, the number of partial regions R250, which is nine.

The learning execution unit 112 inputs the teaching data again to the machine learning model 200 that is previously learned, calculates the feature spectra Sp illustrated in FIG. 5, and registers the feature spectra Sp as the known feature spectrum group GKSp in the memory 120.

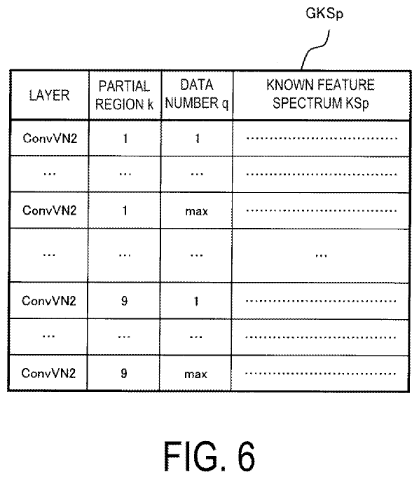

FIG. 6 is an explanatory diagram illustrating a configuration of the known feature spectrum group GKSp. In this example, the known feature spectrum group GKSp obtained from an output of the ConvVN2 layer 250 is illustrated. Note that registration of a known feature spectrum group obtained from an output of at least one vector neuron layer is only required as the known feature spectrum group GKSp. A known feature spectrum group obtained from an output of the ConvVN1 layer 240 or the RegressVN layer 260 may be registered.

Each record in the known feature spectrum group GKSp includes a parameter k indicating the order of the partial region Rn in the layer, a parameter c indicating the class, a parameter q indicating the data number, and a known feature spectrum KSp. The known feature spectrum KSp is the same as the feature spectrum Sp in FIG. 5.

The parameter k of the partial region Rn is a value indicating any one of the plurality of partial regions Rn included in the specific layer, in other words, any one of the plane positions (x, y). In a case of the ConvVN2 layer 250, the number of partial regions R250 is nine, and hence k=1 to 9. The parameter q of the data number indicates a serial number of the teaching data, and is a value from 1 to max. For example, max=5000.

The plurality of pieces of teaching data used in Step S130 are not required to be the same as the plurality of pieces of teaching data used in Step S120. When part or entirety of the plurality of pieces of teaching data used in Step S120 is also used in Step S130, there is no need to prepare new teaching data, which is advantageous.

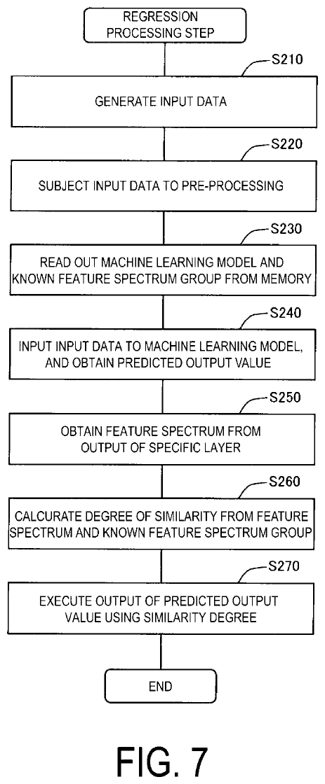

FIG. 7 is a flowchart illustrating a processing procedure of regression processing steps using the machine learning model 200 that is previously learned. In Step S210. the regression processing unit 114 generates input data. In the present exemplary embodiment, when hand-written characters are captured by the camera 400, the character image of 28×28 pixels is generated as input data. In Step S220, the regression processing unit 114 executes pre-processing for input data as appropriate. As the pre-processing, processing such as resolution adjustment and data normalization (min-max normalization) may be used. The pre-processing may be omitted. In Step S230, the regression processing unit 114 reads out the machine learning model 200 that is previously learned and the known feature spectrum group GKSp from the memory 120.

In Step S240, the regression processing unit 114 inputs the input data to the machine learning model 200, and obtains the predicted output value θpr. In the present exemplary embodiment, the predicted output value θpr is a rotation angle of the hand-written characters included in the input data. In Step S250, the regression processing unit 114 obtains the feature spectrum Sp illustrated in FIG. 5, using an output of the ConvVn2 layer 250 being a specific layer. In Step S260, the degree of similarity arithmetic unit 310 calculates a degree of similarity using the feature spectrum Sp obtained in Step S250 and the known feature spectrum group GKSp illustrated in FIG. 6. The degree of similarity is an index indicating a degree of similarity at which the input data is similar to the teaching data. A method for calculating a degree of similarity is described later.

In Step S270, the output execution unit 320 outputs the predicted output value θpr using the degree of similarity.

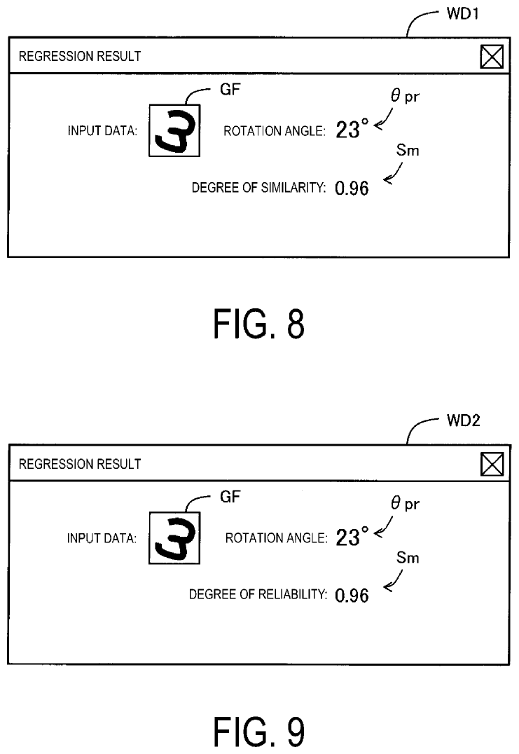

FIG. 8 is an explanatory diagram illustrating an output example of a regression processing result. On a display window WD1 for displaying a result of the regression processing, an image of input data GF, the predicted output value θpr, and the degree of similarity Sm are displayed. In this example, the input data GF is an image showing a rotated hand-written number “3”. The predicted output value θpr is “23 degrees”, and the degree of similarity Sm is “0.96”. The predicted output value θpr can be obtained by subtracting 5.0 from an output of the RegressVN layer 260 and multiplying the resultant by 180. A user is allowed to determine whether the predicted output value θpr is reliable based on a value of the degree of similarity Sm. The range within which the degree of similarity Sm may fall is from −1 to +1. In the example of FIG. 8, the degree of similarity Sm is close to 1, and hence it can be determined that the predicted output value θpr is reliable.

FIG. 9 is an explanatory diagram illustrating another output example of a regression processing result. On a display window WD2 for displaying a result of the regression processing, an image of the input data GF, the predicted output value θpr, and the degree of similarity Sm are also displayed. The degree of similarity Sm is referred to as a “degree of reliability”, which is only a difference from FIG. 8. In this example, a user is also allowed to determine whether the predicted output value θpr is reliable based on a value of the degree of reliability.

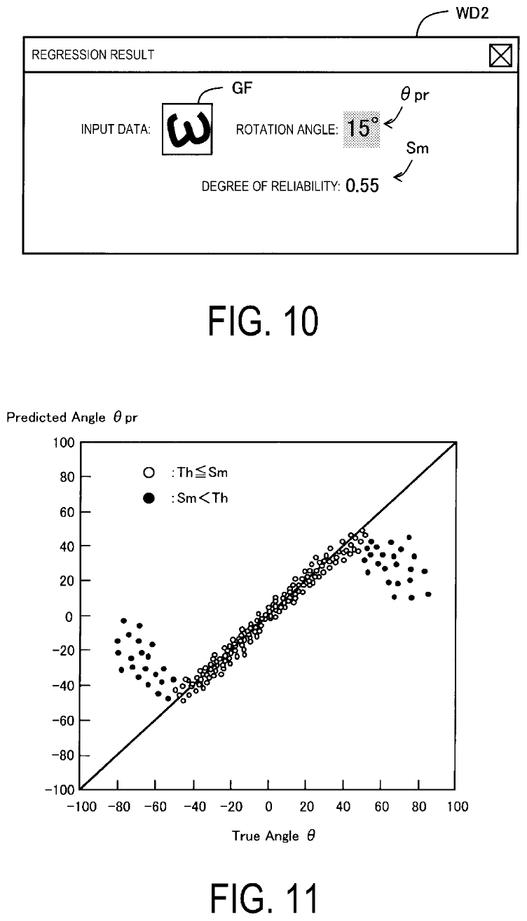

FIG. 10 is an explanatory diagram further illustrating another output example of a regression processing result. In this example, a display example is shown where a low value of the degree of reliability is displayed on the result display window WD2 in FIG. 9. Here, the value of the degree of similarity Sm as a degree of reliability is 0.55, which is significantly low. Thus, a display mode of the predicted output value θpr is a mode indicating that the degree of reliability is low, which is different from FIG. 9. Specifically, in this display mode, the numeral value of the predicted output value θpr is hatched, which is difficult to visually recognize. For example, when the degree of similarity Sm is equal to or greater than a predetermined threshold value, the output execution unit 320 may determine that the predicted output value θpr is valid and may execute an output as in FIG. 9. When the degree of similarity Sm is less than the threshold value, the output execution unit 320 may determine that the predicted output value θpr is invalid and may execute an output as in FIG. 10. Further, instead of displaying the predicted output value θpr in the different display modes depending on the degree of similarity Sm being less than the threshold value or equal to or greater than the threshold value, an output of the predicted output value θpr may be stopped when the degree of similarity Sm is less than the threshold value. In any case, when the degree of similarity Sm is less than the threshold value, the degree of reliability of the predicted output value θpr is low. Thus, it can be determined that the predicted output value θpr obtained by the machine learning model 200 is invalid.

FIG. 11 is an explanatory diagram illustrating an experiment result of regression processing using the machine learning model 200 that is previously learned. A number of hand-written character images are used as input image, and a rotation angle thereof is obtained as the predicted output value θpr by the machine learning model 200. Here, a result obtained therefrom is shown. The horizontal axis indicates a true rotation angle θ, and the vertical axis indicates the predicted output value θpr. The white circle shows a result that the degree of similarity Sm is equal to or greater than a threshold value Th, and the black circle shows a result that the degree of similarity Sm is less than the threshold value Th. In this example, the threshold value Th is set to 0.95. As illustrated in FIG. 3, in the teaching data, the rotation angle θ is set so as to fall within the range from −45 degrees to +45 degrees. In the result shown in FIG. 11, the satisfactory predicted output value θpr is obtained within the range from −50 degrees to +50 degrees. Further, outside the range from the range from −50 degrees to +50 degrees, the degree of similarity Sm of the predicted output value θpr tends to be significantly lowered. As described with reference to the examples in FIG. 8 to FIG. 10, when the predicted output value θpr is output using the degree of similarity Sm, a high degree of similarity Sm and a highly reliable predicted output value θpr can be obtained, which is advantageous.

As described above, in the exemplary embodiment described above, the regression processing can be executed at high accuracy using the machine learning model 200 including the vector neural network. Further, the predicted output value θpr is output using the degree of similarity Sm. Thus, the predicted output value θpr that is reliable can be obtained.

### B. Method of Calculating Degree of Similarity

For example, any one of the following methods may be employed as the arithmetic method of the degree of similarity described above.

(1) A first arithmetic method M1 for obtaining a degree of similarity without considering correspondence of partial regions Rn of the feature spectrum Sp and the known feature spectrum group GKSp.

(2) A second arithmetic method M2 for obtaining a degree of similarity in the corresponding partial regions Rn of the feature spectrum Sp and the known feature spectrum group GKSp.

(3) A third arithmetic method M3 for obtaining a degree of similarity without considering the partial region Rn at all

In the following description, description is sequentially made on methods of calculating a degree of similarity from an output of the ConvVN2 layer 250 while following those arithmetic methods M1, M2, and M3.

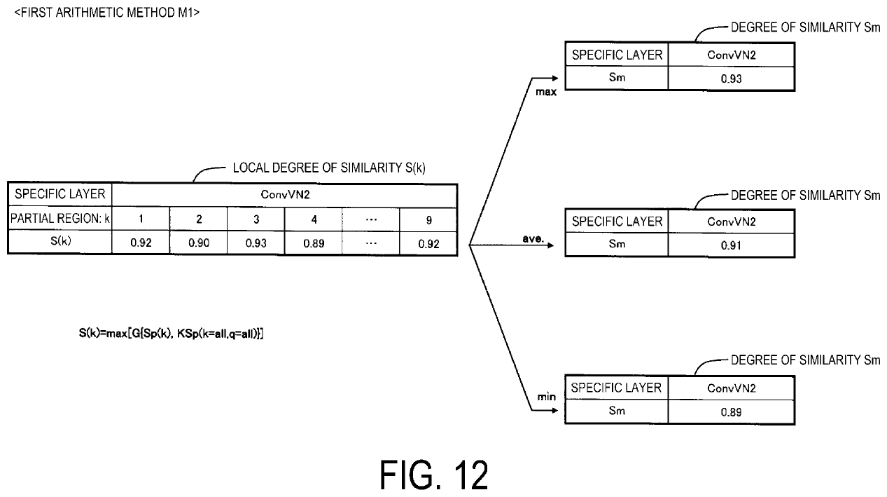

FIG. 12 is an explanatory diagram illustrating the first arithmetic method M1 for obtaining a degree of similarity. In the first arithmetic method M1, first, a local degree of similarity S(k) of a partial region k is calculated from an output of the ConvVN2 layer 250 being the specific layer, in accordance with an equation described below. In the machine learning model 200 in FIG. 2, the number of partial regions R250 of the ConvVN2 layer 250 is nine, and hence the parameter k indicating the partial region is 1 to 9. Any one of three types of the degrees of similarity Sm, which are illustrated on the right side of FIG. 12, is calculated from the local degree of similarity S(k).

In the first arithmetic method M1, the local degree of similarity S(k) is calculated using the following equation.

S(k)=max[G{Sp(k),KSp(k=all,q=all)}] (B1),

where

k is a parameter indicating the partial region Rn;

q is a parameter indicating the data number;

G{a, b} is the function for obtaining a degree of similarity between a and b;

Sp(k) is the feature spectrum obtained from an output of the specified partial region k of the specific layer in accordance with the input data;

KSp(k=all, q=all) are known feature spectra for all the data numbers q in all the partial regions k of the specific layer in the known feature spectrum group GKSp illustrated in FIG. 6; and

max[X] is a logical operation for obtaining a maximum value of the values X.

Note that, as the function G{a, b} for obtaining the degree of similarity, for example, an equation for obtaining a cosine degree of similarity or a degree of similarity corresponding to a distance may be used.

The three types of the degrees of similarity Sm, which are illustrated on the right side of FIG. 12, are obtained by obtaining a maximum value, an average value, or a minimum value of the local degree of similarity S(k) of the plurality of partial regions k. A calculation to be used is selected from the maximum value, and the average value, and the minimum value, according to a usage purpose of the degree of similarity Sm. A calculation to be used is selected from the three calculations in advance through experimental or empirical observation of a user. In the exemplary embodiment described above, the minimum value of the local degree of similarity S(k) is obtained, and thus the degree of similarity Sm is determined.

As described above, in the first arithmetic method M1 for obtaining a degree of similarity,

(1) the local degree of similarity S(k) is obtained, the local degree of similarity S(k) being a degree of similarity between the feature spectrum Sp obtained from an output of the specified partial region k of the specific layer in accordance with the input data and all the known feature spectra KSp associated with the specific layer, and

(2) the degree of similarity Sm is obtained by obtaining the maximum value, the average value, or the minimum value of the local degree of similarity S(k) for the plurality of partial regions k.

With the first arithmetic method M1, the degree of similarity Sm can be obtained in a calculation and a procedure that are relatively simple.

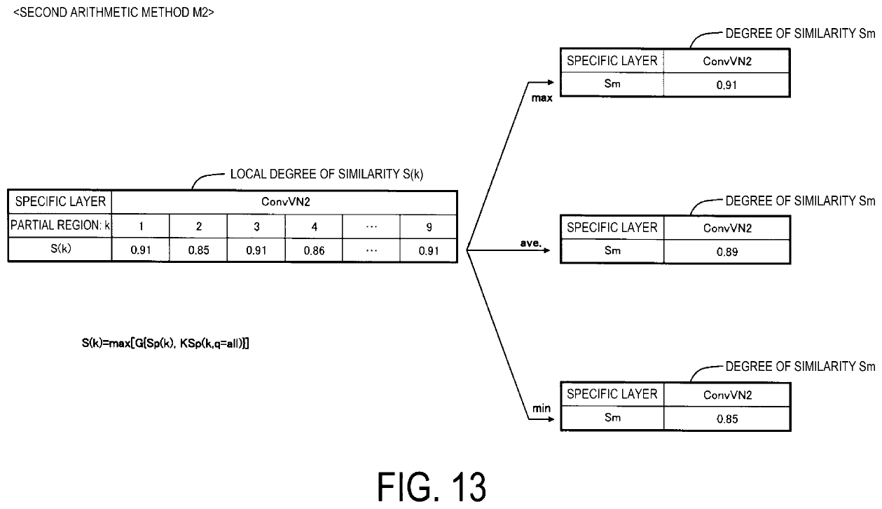

FIG. 13 is an explanatory diagram illustrating the second arithmetic method M2 for obtaining a degree of similarity. In the second arithmetic method M2, the local degree of similarity S(k) is calculated using the following equation in place of Equation (B1) given above.

S(k)=max[G{Sp(k),KSp(k,q=all)}] (B2),

where

KSp(k, q=all) are known feature spectra for all the data numbers q in the specified partial region k of the specific layer in the known feature spectrum group GKSp illustrated in FIG. 6.

In the first arithmetic method M1 described above, the known feature spectrum KSp(k=all, q=all) in all the partial regions k of the specific layer is used. In contrast, the second arithmetic method M2 only uses the known feature spectrum KSp(k, q=all) in the partial region k same as the partial region k of the feature spectrum Sp(k). Other contents of the second arithmetic method M2 are similar to those of the first arithmetic method M1.

In the second arithmetic method M2 for obtaining a degree of similarity,

(1) the local degree of similarity S(k) is obtained, the local degree of similarity S(k) being a degree of similarity between the feature spectrum Sp obtained from an output of the specified partial region k of the specific layer in accordance with the input data and all the known feature spectra KSp associated with the specified partial region K of the specific layer, and

(2) the degree of similarity Sm is obtained by obtaining the maximum value, the average value, or the minimum value of the local degree of similarity S(k) for the plurality of partial regions k.

With the second arithmetic method M2, the degree of similarity Sm can also be obtained in a calculation and a procedure that are relatively simple.

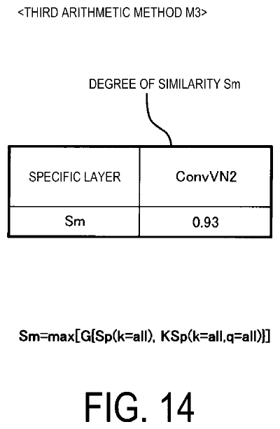

FIG. 14 is an explanatory diagram illustrating the third arithmetic method M3 for obtaining a degree of similarity. In the third arithmetic method M3, the degree of similarity Sm is calculated from an output of the ConvVN2 layer 250 being the specific layer, without obtaining the local degree of similarity S(k).

The degree of similarity Sm obtained in the third arithmetic method M3 is calculated using the following equation.

Sm=max[G{Sp(k=all),KSp(k=all,q=all)}} (B3),

where

Sp(k=all) is the feature spectrum obtained from an output of all the partial regions k of the specific layer in accordance with the input data.

As described above, with the third arithmetic method M3 for obtaining a degree of similarity, there is obtained (1) the degree of similarity Sm being a degree of similarity between all the feature spectra Sp obtained from an output of the specific layer according to the input data and all the known feature spectra KSp associated with the specific layer.

With the third arithmetic method M3, the degree of similarity Sm can be obtained in a calculation and a procedure that are further simple.

Each of the three arithmetic methods M1 to M3 described above is a method for calculating a degree of similarity using an output of one specific layer. However, a calculation for a degree of similarity can be executed while one or more of the plurality of vector neuron layers 240, 250, and 260 illustrated in FIG. 2 is regarded as the specific layer. For example, when the plurality of specific layers are used, it is preferred that the minimum value or the average value of the plurality of degrees of similarity obtained from the plurality of specific layers be used as a final degree of similarity.

### C. Arithmetic Method of Output Vector in Each Layer of Machine Learning Model

Arithmetic methods for obtaining an output of each of the layers illustrated in FIG. 2 are as follows.

For each of the nodes of the PrimeVN layer 230, a vector output of the node is obtained by regarding scholar outputs of 1×1×32 nodes of the Conv layer 220 as 32-dimensional vectors and multiplying the vectors by a transformation matrix. In the transformation matrix, a surface size is a 1×1 kernel element. The transformation matrix is updated by learning of the machine learning model 200. Note that processing in the Conv layer 220 and processing in the PrimeVN layer 230 may be integrated so as to configure one primary vector neuron layer.

When the PrimeVN layer 230 is referred to as a “lower layer L”, and the ConvVN1 layer 240 that is adjacent on the upper side is referred to as an “upper layer L+1”, an output of each node of the upper layer L+1 is determined using the following equations.

$$\begin{matrix}[ Mathematical Expression 2 ] & \\ {v}_{ij} = {W}_{ij}^{L} {M}_{i}^{L} & ( E1 )\end{matrix}$$

$${u}_{j} = {\sum }_{i} {v}_{ij} \qquad ( E2 )$$

$${a}_{j} = F ( ‖ {u}_{j} ‖ ) \qquad ( E3 )$$

$${M}_{j}^{L + 1} = {a}_{j} \times \frac{1}{‖ {u}_{j} ‖} {u}_{j} \qquad ( E4 )$$

where

M^{L}ᵢ is an output vector of an i-th node in the lower layer L;

M^{L+1}ⱼ is an output vector of a j-th node in the upper layer L+1;

vᵢⱼ is a predicted vector of the output vector M^{L+1}ⱼ;

W^{L}ᵢⱼ is a predicted matrix for calculating the predicted vector vᵢⱼ from the output vector M^{L}ᵢ of the lower layer L;

uⱼ is a sum vector being a sum of the predicted vector vᵢⱼ, that is, a linear combination;

aⱼ is an activation value being a normalization coefficient obtained by normalizing a norm |uⱼ| of the sum vector uⱼ; and

F(X) is a normalization function for normalizing X.

For example, as the normalization function F(X), Equation (E3a) or Equation (E3b) given below may be used.

$$\begin{matrix}[ Mathematical Expression 3 ] & \\ {a}_{j} = F ( ‖ {u}_{j} ‖ ) = softmax ( ‖ {u}_{j} ‖ ) = \frac{exp ( β ‖ {u}_{j} ‖ )}{{\sum }_{k} exp ( β ‖ {u}_{k} ‖ )} & ( E3a )\end{matrix}$$

$${a}_{j} = F ( ‖ {u}_{j} ‖ ) = \frac{‖ {u}_{j} ‖}{{\sum }_{k} ‖ {u}_{k} ‖} \qquad ( E3b )$$

where

k is an ordinal number for all the nodes in the upper layer L+1; and

β is an adjustment parameter being a freely-selected positive coefficient, for example, β=1.

In addition to this, the Sigmoid function may be used as a normalization function F(X). The Sigmoid function is used to collectively refer to a function with an S-like curve in a graph. Examples thereof include a logistic function F(x)=1/(1+exp(−βx)) and a hyperbolic tangent function tanh(x).

In Equation (E3a) given above, the activation value aⱼ is obtained by normalizing the norm |uⱼ| of the sum vector uⱼ with the softmax function for all the nodes in the upper layer L+1. Meanwhile, in Equation (E3b), the norm |uⱼ| of the sum vector uⱼ is divided by the sum of the norm |uⱼ| of all the nodes in the upper layer L+1. With this, the activation value aⱼ is obtained. Note that, as the normalization function F(X), a function other than Equation (E3a) and Equation (E3b) may be used.

For sake of convenience, the ordinal number i in Equation (E2) given above is allocated to each of the nodes in the lower layer L for determining the output vector M^{L+1}ⱼ of the j-th node in the upper layer L+1, and is a value from 1 to n. Further, the integer n is the number of nodes in the lower layer L for determining the output vector M^{L+1}ⱼ of the j-th node in the upper layer L+1. Therefore, the integer n is provided in the equation given below.

n=Nk×Nc (E5)

Here, Nk is a kernel surface size, and Nc is the number of channels of the PrimeVN layer 230 being a lower layer. In the example of FIG. 2, Nk=9 and Nc=16. Thus, n=144.

One kernel used for obtaining an output vector of the ConvVN1 layer 240 has 144 (3×3×16) elements, each of which has a surface size being a kernel size of 3×3, and has a depth being the number of channels in the lower layer of 16. Each of the elements is a prediction matrix W^{L}ᵢⱼ. Further, in order to generate output vectors of 12 channels of the ConvVN1 layer 240, 12 kernel pairs are required. Therefore, the number of predication matrices W^{L}ᵢⱼ of the kernels used for obtaining output vectors of the ConvVN1 layer 240 is 1,728 (144×12). Those prediction matrices W^{L}ᵢⱼ are updated by learning of the machine learning model 200.

As understood from Equation (E1) to Equation (E4) given above, the output vector M^{L+1}ⱼ of each of the nodes in the upper layer L+1 is obtained by the following calculation.

(A) the predicted vector vᵢⱼ is obtained by multiplying the output vector M^{L}ᵢ of each of the nodes in the lower layer L by the prediction matrix W^{L}ᵢⱼ;

(b) the sum vector uⱼ being a sum of the predicted vectors vᵢⱼ of the respective nodes in the lower layer L, which is a linear combination, is obtained;

(c) the activation value aⱼ being a normalization coefficient is obtained by normalizing the norm |uⱼ| of the sum vector uⱼ; and

(d) the sum vector uⱼ is divided by the norm |uⱼ|, and is further multiplied by the activation value aⱼ.

Note that the activation value aⱼ is a normalization coefficient that is obtained by normalizing the norm |uⱼ| for all the nodes in the upper layer L+1. Therefore, the activation value aⱼ can be considered as an index indicating a relative output intensity of each of the nodes among all the nodes in the upper layer L+1. The norm used in Equation (E3) and Equation (4) is an L2 norm indicating a vector length in a general example. In this case, the activation value aⱼ corresponds to a vector length of the output vector M^{L+1}ⱼ. The activation value aⱼ is only used in Equation (E3) and Equation (E4) given above, and hence is not required to be output from the node. However, the upper layer L+1 may be configured so that the activation value aⱼ is output to the outside.

A configuration of the vector neural network is substantially the same as a configuration of the capsule network, and the vector neuron in the vector neural network corresponds to the capsule in the capsule network. However, the calculation with Equation (E1) to Equation (E4) given above, which are used in the vector neural network, is different from a calculation used in the capsule network. The most significant difference between the two calculations is that, in the capsule network, the predicted vector vᵢⱼ in the right side of Equation (E2) given above is multiplied by a weight and the weight is searched by repeating dynamic routing for a plurality of times. Meanwhile, in the vector neural network of the present exemplary embodiment, the output vector M^{L+1}ⱼ is obtained by calculating Equation (E1) to Equation (E4) given above once in a sequential manner. Thus, there is no need of repeating dynamic routing, and the calculation can be executed faster, which are advantageous points. Further, the vector neural network of the present exemplary embodiment has a less memory amount, which is required for the calculation, than the capsule network. According to an experiment conducted by the inventor of the present disclosure, the vector neural network requires approximately ⅓ to ½ of the memory amount of the capsule network, which is also an advantageous point.

The vector neural network is similar to the capsule network in that a node with an input and an output in a vector expression is used. Therefore, the vector neural network is also similar to the capsule network in that the vector neuron is used. Further, in the plurality of layers 220 to 260, the upper layers indicate a feature of a larger region, and the lower layers indicate a feature of a smaller region, which is similar to the general convolution neural network. Here, the “feature” indicates a feature included in input data to the neural network. In the vector neural network or the capsule network, an output vector of a certain node contains space information indicating information relating to a spatial feature expressed by the node. In this regard, the vector neural network or the capsule network are superior to the general convolution neural network. In other words, a vector length of an output vector of the certain node indicates an existence probability of a feature expressed by the node, and the vector direction indicates space information such as a feature direction and a scale. Therefore, vector directions of output vectors of two nodes belonging to the same layer indicate positional relationships of the respective features. Alternatively, it can also be said that vector directions of output vectors of the two nodes indicate feature variations. For example, when the node corresponds to a feature of an “eye”, a direction of the output vector may express variations such as smallness of an eye and an almond-shaped eye. It is said that, in the general convolution neural network, space information relating to a feature is lost due to pooling processing. As a result, as compared to the general convolution neural network, the vector neural network and the capsule network are excellent in a function of distinguishing input data.

The advantageous points of the vector neural network can be considered as follows. In other words, the vector neural network has an advantageous point in that an output vector of the node expresses features of the input data as coordinates in a successive space. Therefore, the output vectors can be evaluated in such a manner that similar vector directions show similar features. Further, even when features contained in input data are not covered in teaching data, the features can be interpolated and can be distinguished from each other, which is also an advantageous point. In contrast, in the general convolution neural network, disorderly compaction is caused due to pooling processing, and hence features in input data cannot be expressed as coordinates in a successive space, which is a drawback.

An output of each of the node in the ConvVN2 layer 250 and the RegressVN layer 260 are similarly determined through use Equation (E1) to Equation (E4) given above, and detailed description thereof is omitted. A resolution of the RegressVN layer 260 being the uppermost layer is 1×1, and the number of channels thereof is M.

In the RegressVN layer 260, the linear function in Equation (A2) given above or the like may be used as an active function in place of Equation (E3) given above. In other words, the output vector of the RegressVN layer 260 is converted into the predicted output value θpre by the linear function in Equation (A2) given above. Alternatively, the above-mentioned Sigmoid function may be used as an active function.

In the exemplary embodiment described above, as the machine learning model 200, the vector neural network that obtains an output vector by a calculation with Equation (E1) to Equation (E4) given above is used. Instead, the capsule network disclosed in each of U.S. Pat. No. 5,210,798 and WO 2019/083553 may be used.

Other Aspects:

The present disclosure is not limited to the exemplary embodiment described above, and may be implemented in various aspects without departing from the spirits of the disclosure. For example, the present disclosure can also be achieved in the following aspects. Appropriate replacements or combinations may be made to the technical features in the above-described exemplary embodiment which correspond to the technical features in the aspects described below to solve some or all of the problems of the disclosure or to achieve some or all of the advantageous effects of the disclosure. Additionally, when the technical features are not described herein as essential technical features, such technical features may be deleted appropriately.

(1) According to a first aspect of the present disclosure, there is provided a regression processing device configured to execute regression processing of obtaining a predicted output value with respect to input data using a machine learning model including a vector neural network including a plurality of vector neuron layers. The regression processing device includes a regression processing unit configured to execute the regression processing, and a memory configured to store a known feature spectrum group obtained from an output of a specific layer of the machine learning model when a plurality of pieces of teaching data are input to the machine learning model. The regression processing unit is configured to execute processing (a) of obtaining the predicted output value with respect to the input data using the machine learning model, processing (b) of reading out the known feature spectrum group from the memory, processing (c) of calculating a degree of similarity relating to the predicted output value between the known feature spectrum group and a feature spectrum obtained from an output of the specific layer when the input data is input to the machine learning model, and processing (d) of outputting the predicted output value using the degree of similarity.

With this device, the regression processing can be executed at high accuracy using the machine learning model including the vector neural network. Further, the predicted output value is output using the degree of similarity. Thus, a high degree of similarity and a highly reliable predicted output value can be obtained.

(2) In the regression processing device described above, the processing (d) may involve processing of outputting the degree of similarity, together with the predicted output value.

With this device, a user is allowed to determine whether the predicted output value is reliable based on the degree of similarity.

(3) In the regression processing device described above, the processing (d) may involve processing of outputting of a degree of reliability of the predicted output value according to the degree of similarity, together with the predicted output value.

With this device, a user can easily understand the degree of reliability of the predicted output value.

(4) In the regression processing device described above, the processing (d) may involve processing of determining that the predicted output value is valid when the degree of similarity is equal to or greater than a predetermined threshold value and determining that the predicted output value is invalid when the degree of similarity is less than the threshold value.

With this device, when the degree of similarity is less than the threshold value, the degree of reliability of the predicted output value is low. Thus, it can be determined that the predicted output value obtained by the machine learning model is invalid.

(5) In the regression processing device described above, the specific layer may have a configuration in which a vector neuron arranged in a plane defined with two axes including a first axis and a second axis is arranged as a plurality of channels along a third axis being a direction different from the two axes. The feature spectrum may be any one of (i) a first type of a feature spectrum obtained by arranging a plurality of element values of an output vector of a vector neuron at one plane position in the specific layer, over the plurality of channels along the third axis, (ii) a second type of a feature spectrum obtained by multiplying each of the plurality of element values of the first type of the feature spectrum by an activation value corresponding to a vector length of the output vector, and (iii) a third type of a feature spectrum obtained by arranging the activation value at one plane position in the specific layer, over the plurality of channels along the third axis.

With this device, the feature spectrum can easily be obtained.

(6) According to a second aspect of the present disclosure, there is provided a method of executing regression processing of obtaining a predicted output value with respect to input data using a machine learning model including a vector neural network including a plurality of vector neuron layers. The method includes (a) obtaining the predicted output value with respect to the input data using the machine learning model, (b) reading out, from a memory, a known feature spectrum group obtained from an output of a specific layer of the machine learning model when a plurality of pieces of teaching data are input to the machine learning model, (c) calculating a degree of similarity relating to the predicted output value between the known feature spectrum group and a feature spectrum obtained from an output of the specific layer when the input data is input to the machine learning model, and (d) outputting the predicted output value using the degree of similarity.

(7) According to a third aspect of the present disclosure, there is provided a non-transitory computer-readable storage medium storing a computer program for causing a processor to execute regression processing of obtaining a predicted output value with respect to input data using a machine learning model including a vector neural network including a plurality of vector neuron layers. The computer program causes the processor to (a) obtain the predicted output value with respect to the input data using the machine learning model, (b) read out, from a memory, a known feature spectrum group obtained from an output of a specific layer of the machine learning model when a plurality of pieces of teaching data are input to the machine learning model, (c) calculate a degree of similarity relating to the predicted output value between the known feature spectrum group and a feature spectrum obtained from an output of the specific layer when the input data is input to the machine learning model, and (d) output the predicted output value using the degree of similarity.

The present disclosure may be achieved in various forms other than the above-mentioned aspects. For example, the present disclosure can be implemented in forms including a computer program for achieving the functions of the regression processing device, and a non-transitory storage medium storing the computer program.

What is claimed is:

1. A regression processing device configured to execute regression processing of obtaining a predicted output value with respect to input data using a machine learning model including a vector neural network including a plurality of vector neuron layers, the regression processing device comprising:
a regression processing unit configured to execute the regression processing; and
a memory configured to store a known feature spectrum group obtained from an output of a specific layer of the machine learning model when a plurality of pieces of teaching data are input to the machine learning model, wherein
the regression processing unit is configured to execute:
processing (a) of obtaining the predicted output value with respect to the input data using the machine learning model;
processing (b) of reading out the known feature spectrum group from the memory;
processing (c) of calculating a degree of similarity relating to the predicted output value between the known feature spectrum group and a feature spectrum obtained from an output of the specific layer when the input data is input to the machine learning model; and
processing (d) of outputting the predicted output value using the degree of similarity.

2. The regression processing device according to claim 1, wherein
the processing (d) involves processing of outputting the degree of similarity, together with the predicted output value.

3. The regression processing device according to claim 1, wherein
the processing (d) involves processing of outputting of a degree of reliability of the predicted output value according to the degree of similarity, together with the predicted output value.

4. The regression processing device according to claim 1, wherein
the processing (d) involves processing of determining that the predicted output value is valid when the degree of similarity is equal to or greater than a predetermined threshold value and determining that the predicted output value is invalid when the degree of similarity is less than the threshold value.

5. The regression processing device according to claim 1, wherein
the specific layer has a configuration in which a vector neuron arranged in a plane defined with two axes including a first axis and a second axis is arranged as a plurality of channels along a third axis being a direction different from the two axes, and
the feature spectrum is any one of:
(i) a first type of a feature spectrum obtained by arranging a plurality of element values of an output vector of a vector neuron at one plane position in the specific layer, over the plurality of channels along the third axis;
(ii) a second type of a feature spectrum obtained by multiplying each of the plurality of element values of the first type of the feature spectrum by an activation value corresponding to a vector length of the output vector; and
(iii) a third type of a feature spectrum obtained by arranging the activation value at one plane position in the specific layer, over the plurality of channels along the third axis.

6. A method of executing regression processing of obtaining a predicted output value with respect to input data using a machine learning model including a vector neural network including a plurality of vector neuron layers, the method comprising:
(a) obtaining the predicted output value with respect to the input data using the machine learning model;
(b) reading out, from a memory, a known feature spectrum group obtained from an output of a specific layer of the machine learning model when a plurality of pieces of teaching data are input to the machine learning model;
(c) calculating a degree of similarity relating to the predicted output value between the known feature spectrum group and a feature spectrum obtained from an output of the specific layer when the input data is input to the machine learning model; and
(d) outputting the predicted output value using the degree of similarity.

7. A non-transitory computer-readable storage medium storing a computer program for causing a processor to execute regression processing of obtaining a predicted output value with respect to input data using a machine learning model including a vector neural network including a plurality of vector neuron layers, the computer program causing the processor to:
(a) obtain the predicted output value with respect to the input data using the machine learning model;
(b) read out, from a memory, a known feature spectrum group obtained from an output of a specific layer of the machine learning model when a plurality of pieces of teaching data are input to the machine learning model;
(c) calculate a degree of similarity relating to the predicted output value between the known feature spectrum group and a feature spectrum obtained from an output of the specific layer when the input data is input to the machine learning model; and
(d) output the predicted output value using the degree of similarity.
